(19) United States
(12) Patent Application Publication
(10) Pub. No.: US 2009/0171573 A1
(43) Pub. Date: Jul. 2, 2009

(54) SYSTEM AND METHOD FOR PROVIDING THEME ZONE IN CONNECTION WITH PATH

(75) Inventor: Sang Hun Chang, Seoul (KR)

Correspondence Address: AKERMAN SENTERFITT, P.O. BOX 3188, WEST PALM BEACH, FL, 33402-3188, US

(73) Assignee: THINKWARE SYSTEMS CORPORATION, Seoul (KR)

(21) Appl. No.: 12/298,493

(22) PCT Filed: Feb. 12, 2007
(86) PCT No.: PCT/KR07/00741

§ 371 Date: Oct. 24, 2008

(30) Foreign Application Priority Data
Apr. 27, 2006 (KR) 10-2006-0038043

(51) Int. Cl. G01C 21/36

(52) U.S. Cl. 701/209

(57) ABSTRACT

A system for providing a theme zone in association with a route, the system including: a theme zone database maintaining a theme zone area for each category in association with navigation information, and point of interest (POI) information included in the theme zone area; a theme zone retrieval unit retrieving a theme zone associated with a driving route from the theme zone database by analyzing the driving route of a vehicle; a navigation information generation unit generating the navigation information by including a theme zone area of the retrieved theme zone in the driving route; and a route guidance unit directing a route based on the generated navigation information.

### TECHNICAL FIELD

The present invention relates to a method and system for providing a theme zone in association with a route which previously stores a theme zone area for each category, such as food, fashion, convenience, and the like, retrieves the theme zone associated with a driving route of a vehicle, includes a theme zone area of the retrieved theme zone in navigation information, and directs a route.

### BACKGROUND ART

Navigation systems are systems to provide navigation information for driving of vehicles, such as cars, using satellites. The navigation systems are referred to as automatic navigation systems. Recently, navigation systems provide navigation services, and also a variety of services such as a wireless Internet, video, and call services.

Also, as drivers' needs have increased, qualities of navigation service provided in navigation systems have been improved. As an example, navigation systems provide navigation information in various ways to enable drivers to easily use navigation services while driving. Specifically, navigation systems display route information and point of interest (POI) information together or display directions of driving route in a large size.

Theme zones where restaurants or fashion shops are clustered exist on routes. Existing navigation systems display POI information included in theme zones in point form. Specifically, although existing navigation systems display POI information included in theme zones associated with food districts in point form, navigation systems do not display theme zones on routes as two-dimensional polygon areas.

Accordingly, in a conventional art, drivers may be provided with navigation information to move to theme zones, only when drivers retrieve navigation information by inputting particular POI information or location information. Thus, when drivers do not have particular POI information, drivers may not move to theme zones.

Also, each theme zone is displayed in point form with respect to POI information. Accordingly, while driving, drivers may not recognize theme zones on routes through POI information in point form, and overlook theme zones.

### DISCLOSURE OF INVENTION

### Technical Goals

The present invention provides a method and system for providing a theme zone in association with a route which previously stores a theme zone area for each category, such as food, fashion, convenience, and the like, retrieves a theme zone associated with a driving route of a vehicle, includes a theme zone area of the retrieved theme zone in navigation information, directs a route, and thereby may enable a driver to easily recognize the theme zone.

The present invention also provides a method and system for providing a theme zone in association with a route which provides only a theme zone area included in a category on the route while driving when the category of the theme zone is previously set by a user, and thereby may provide different theme zones for each user.

The present invention also provides a method and system for providing a theme zone in association with a route which receives a district and a search radius of the theme zone from a user, retrieves and provides POI information associated with the received district and search radius.

The present invention also provides a method and system for providing a theme zone in association with a route which stores a recommendation theme zone list based on a theme zone use status of a user and provides the recommendation theme zone list when necessary.

### Technical Solutions

According to an aspect of the present invention, there is provided a system for providing a theme zone in association with a route, the system including: a theme zone database maintaining a theme zone area for each category in association with navigation information, and point of interest (POI) information included in the theme zone area; a theme zone retrieval unit retrieving a theme zone associated with a driving route from the theme zone database by analyzing the driving route of a vehicle; a navigation information generation unit generating the navigation information by including a theme zone area of the retrieved theme zone in the driving route; and a route guidance unit directing a route based on the generated navigation information.

According to another aspect of the present invention, there is provided a system for providing a theme zone in association with a route, the system including: a theme zone database maintaining a theme zone area for each category in association with navigation information, and POI information included in the theme zone area; a user interface unit receiving theme zone selection information from a user; a theme zone retrieval unit retrieving a theme zone associated with the theme zone selection information from the theme zone database; a navigation information generation unit generating the navigation information which sets a representation spot of a theme zone area of the retrieved theme zone as a destination; and a route guidance unit providing navigation based on the generated navigation information.

According to still another aspect of the present invention, there is provided a method of providing a theme zone in association with a route, the method including: maintaining a theme zone area for each category in association with navigation information, and POI information included in the theme zone area in a theme zone database; retrieving a theme zone associated with a driving route from the theme zone database by analyzing the driving route of a vehicle; generating navigation information by including a theme zone area of the retrieved theme zone in the driving route; and directing a route based on the generated navigation information.

According to yet another aspect of the present invention, there is provided a method of providing a theme zone in association with a route, the method including: maintaining a theme zone area for each category in association with navigation information, and POI information included in the theme zone area; receiving theme zone selection information from a user; retrieving a theme zone associated with the theme zone selection information from the theme zone database; generating the navigation information of a theme zone area of the retrieved theme zone; and providing navigation based on the generated navigation information.

### BRIEF DESCRIPTION OF DRAWINGS

FIG. 1 is a block diagram illustrating a configuration of a system for providing a theme zone in association with a route according to an embodiment of the present invention;

FIG. 2 is a flowchart illustrating a method of providing a theme zone in association with a route according to another embodiment of the present invention;

FIG. 3 is a diagram illustrating an example of a user interface screen receiving a category of a theme zone according to the present invention;

FIG. 4 is a diagram illustrating an example of a user interface screen receiving a district and a search radius of a theme zone according to the present invention;

FIG. 5 is a diagram illustrating an example of a user interface screen providing a recommendation theme zone list according to the present invention;

FIG. 6 is a diagram illustrating an example of a user interface screen setting an environment of a theme zone according to the present invention;

FIGS. 7 and 8 are diagrams illustrating examples of a user interface screen displaying a theme zone area on a route in a system for providing a theme zone in association with a route according to the present invention; and

FIG. 9 is a flowchart illustrating a method of providing a theme zone in association with a route according to still another embodiment of the present invention.

### BEST MODE FOR CARRYING OUT THE INVENTION

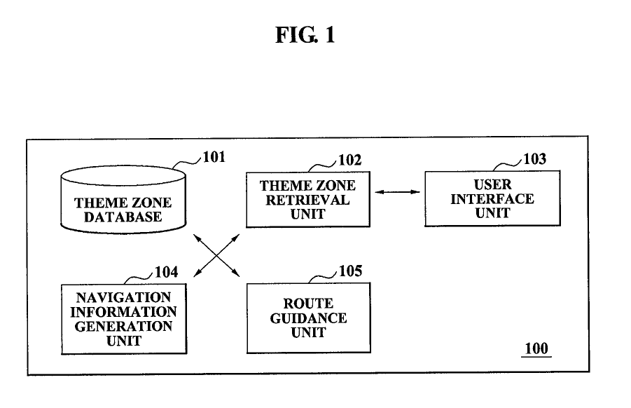

FIG. 1 is a block diagram illustrating a configuration of a system for providing a theme zone in association with a route according to an embodiment of the present invention.

The system for providing a theme zone in association with a route 100, hereinafter, a theme zone providing system 100, includes a theme zone database 101, a theme zone retrieval unit 102, a navigation information generation unit 104, and a route guidance unit 1O5. The theme zone database 101 maintains a theme zone area for each category in association with navigation information, and point of interest (POI) information included in the theme zone area. The theme zone retrieval unit 102 retrieves a theme zone associated with a driving route from the theme zone database by analyzing the driving route of a vehicle. The navigation information generation unit 104 generates the navigation information by including a theme zone area of the retrieved theme zone in the driving route. The route guidance unit 105 directs a route based on the generated navigation information.

The theme zone providing system 100 is a route guidance system for safe driving, and may be used in a navigation system, a location based service, or a web.

Also, according to an embodiment of the present invention, the theme zone providing system 100 further includes a user interface unit 103. The user interface unit 103 receives a category, a district, and a search radius of the theme zone, recommendation theme zone information, or distance information of an audio guidance point associated with the theme zone from a user. The theme zone retrieval unit 102 retrieves a theme zone corresponding to the received content described above. The navigation information generation unit 104 may generate the navigation information by including a theme zone area of the retrieved theme zone in the driving route.

According to another embodiment of the present invention, the navigation information generation unit 104 displays a map associated with the driving route on a screen, and generates the navigation information to enable a theme zone representation icon to be located in a center of the theme zone area, when a position of the map is changed according to a vehicle's driving, and the theme zone area is included in the map on the screen.

According to still another embodiment of the present invention, the route guidance unit 105 may direct the route by 1) not displaying the theme zone area, 2) displaying the theme zone representation icon, or 3) displaying the theme zone representation icon and the theme zone area depending on a map level on a screen.

According to yet another embodiment of the present invention, the theme zone providing system 100 does not automatically provide the theme zone while driving, receives the theme zone from the user, and thereby may provide the route for the theme zone. For this, the user interface unit 103 receives theme zone selection information from the user, and the theme zone retrieval unit 102 retrieves a theme zone associated with the theme zone selection information from the theme zone database 101. Also, the navigation information generation unit 104 generates the navigation information which sets a representation spot of a theme zone area of the theme zone as a destination. The route guidance unit 105 provides navigation based on the generated navigation information. In this instance, the theme zone database 101 sets and stores a shop, which is located in a center of a coordinate of the theme zone area, as the representation spot. The navigation information generation unit 104 generates navigation information which sets a representation spot of the shop, which is located in the center of the coordinate of the theme zone area, as the destination.

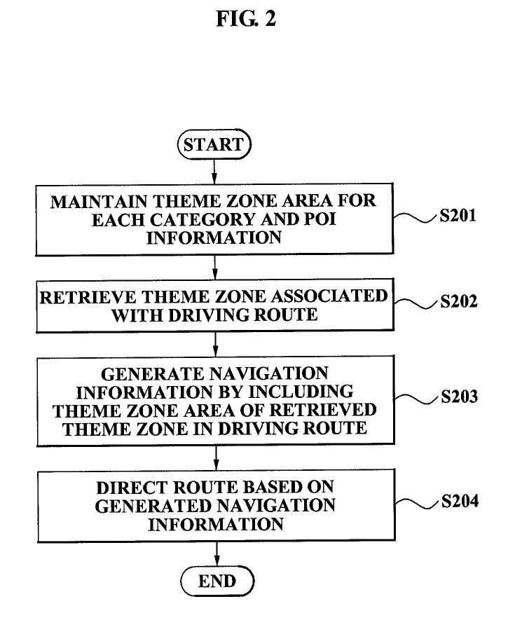

FIG. 2 is a flowchart illustrating a method of providing a theme zone in association with a route according to another embodiment of the present invention. The method of providing a theme zone in association with a route according to the other embodiment of the present invention may be performed in a system for providing a theme zone in association with a route, i.e. theme zone providing system 100 illustrated in FIG. 1.

In operation S201, a theme zone database 101 of the theme zone providing system 100 maintains a theme zone area for each category in association with navigation information, and POI information included in the theme zone area.

The navigation information is information required when directing a route. Map information such as a text, image, and a video file and audio information such as an audio file may be combined in the navigation information. The theme zone area may be represented in a two dimensional polygon area. Also, the theme zone area is an area where a particular type of business, such as restaurants, fashion shops, accommodations, cultural facilities, and the like, are clustered, for example, ‘Food district’ in Apgujeong town or ‘Fashion outlet district’ in Moonjeong town. According to an embodiment of the present invention, the theme zone providing system 100 may store the theme zone area in coordinate form in the theme zone database 101. Also, the POI information is information of each shop included in the theme zone area. As an example, information that ‘Eigenpost’ or ‘Levi's’ store is located in the ‘Fashion outlet district’ in Moonjeong town, may be the POI information. In this instance, the theme zone providing system 100 may manage the theme zone area by classifying the theme zone area into corresponding category, such as food, fashion, accommodation, and the like.

In operation S202, a theme zone retrieval unit 102 of the theme zone providing system 100 retrieves a theme zone associated with a driving route from the theme zone database 101 by analyzing the driving route of a vehicle. The theme zone retrieval unit 102 may determine whether the theme zone exists in the driving route by ascertaining a location of a running vehicle without a user's separate request.

In this instance, according to an embodiment of the present invention, the theme zone retrieval unit 102 previously receives a category, a district, a search radius of the theme zone, or recommendation theme zone information from a user and may retrieve a theme zone corresponding to the received content described above, before retrieving the theme zone associated with the driving route of the vehicle.

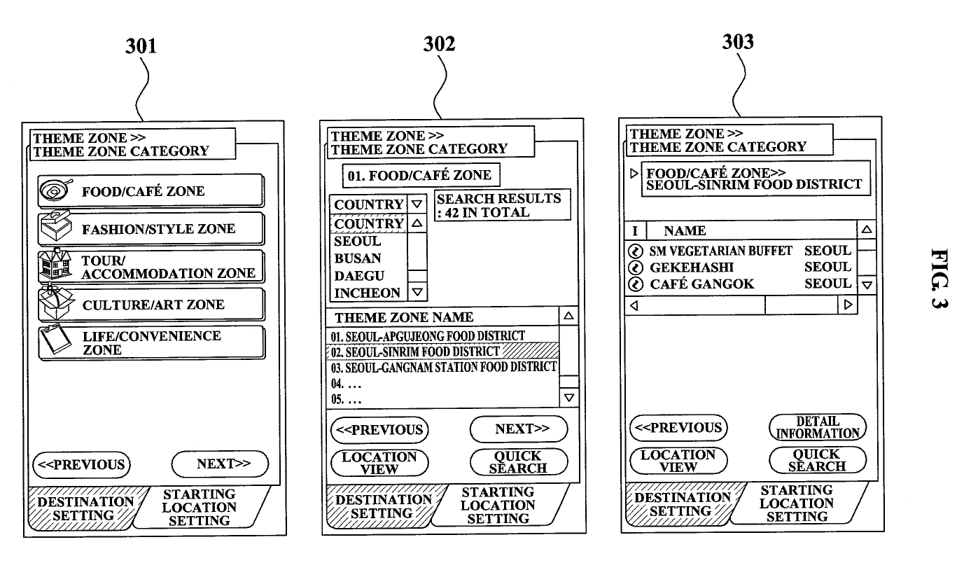

Hereinafter, the method of providing a theme zone in association with a route is described in greater detail with reference to FIGS. 3, 4, and 5.

FIG. 3 is a diagram illustrating an example of a user interface screen receiving a category of a theme zone according to the present invention.

As illustrated in 301 of FIG. 3, the theme zone providing system 100 maintains a theme zone area by classifying the theme zone area into each category, e.g. a food/café zone, a fashion/style zone, a tour/accommodation zone, a culture/art zone, and a life/convenience zone. The theme zone providing system 100 may receive at least one category of the above-described categories from a user.

As illustrated in 302 of FIG. 3, the theme zone providing system 100 may receive district information about at least one district from among district information of districts of the theme zone area included in the selected category from the user. The theme zone providing system 100 may manage the theme zone by classifying the theme zone area into each district such as ‘Seoul’, ‘Busan’, ‘Daegu’, ‘Incheon’, ‘Gyeonggi’, and the like. Accordingly, the theme zone providing system 100 may provide a theme zone list as the theme zone area included in the received category and the received district information. As illustrated in 302 of FIG. 3, the theme zone list may include ‘Seoul-Apgujeong food district’, ‘Seoul-Sinrim food district’, and the like. In FIG. 3, a theme zone list, provided when the food/cafe zone is selected as the category and ‘Seoul’ is selected as the district information, is illustrated.

As illustrated in 303 of FIG. 3, the theme zone providing system 100 may provide POI information included in a single theme zone area, when receiving the single theme zone area of theme zone areas included in the theme zone list from the user.

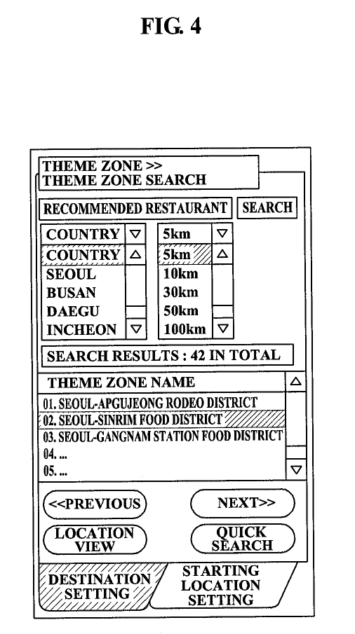

FIG. 4 is a diagram illustrating an example of a user interface screen receiving a district and a search radius of a theme zone according to the present invention. FIG. 4 illustrates the example of the user interface screen for retrieving a theme zone area included in a particular district and search radius, as opposed to for retrieving a theme zone area included in a particular category described with reference to FIG. 3.

As illustrated, a theme zone providing system 100 receives a district and a search radius of a theme zone from a user. The district of the theme zone may be set to an area where the user usually passes or where the user desires to visit while driving or traveling. Also, the search radius may be set when the user desires to receive information about only theme zone area of a smaller range from among theme zone areas included in the district of the theme zone. Since the district of the theme zone is extremely wide, the search radius may be set to ‘5 km’, ‘10 km’, ‘30 km’, and the like, when the user desires to receive the theme zone area in the smaller range.

In this case, the theme zone providing system 100 may retrieve a theme zone area included in the district of the theme zone, and retrieve only a theme zone area within the search radius from the retrieved theme zone area.

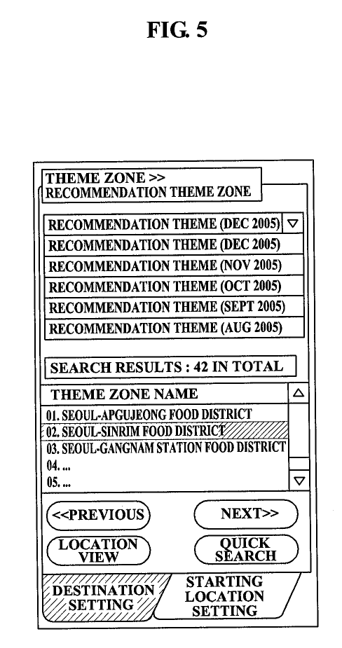

FIG. 5 is a diagram illustrating an example of a user interface screen providing a recommendation theme zone list according to the present invention. As opposed to FIGS. 3 and 4, FIG. 5 illustrates an example of the user interface screen for retrieving a theme zone area included in a recommendation theme zone list based on a theme zone use status of a user.

As illustrated, a theme zone providing system 100 may provide a monthly recommendation theme zone list based on the theme zone use status of the user. The recommendation theme zone list includes a frequently used theme zone area by ascertaining a tendency of users using a theme zone. The theme zone providing system 100 manages the recommendation theme zone list for each category, for each district, for each data, and the like. Also, the theme zone providing system 100 receives a request for recommending theme zone information from the user, and may retrieve a recommendation theme zone list corresponding to the request. The recommendation theme zone information may be various information, e.g. a category, a district, a date, a keyword, and the like, which may be inputted by the user.

In operation S203, the navigation information generation unit 104 of the theme zone providing system 100 generates navigation information by including the theme zone area of the retrieved theme zone in the driving route. When the theme zone associated with the driving route is retrieved, the theme zone providing system 100 may generate the navigation information by identifying map information and audio information associated with the driving route. The map information may be a text, an image, and a video file, and audio information may be an audio file.

In operation S204, the route guidance unit 105 of the theme zone providing system 100 directs a route based on the generated navigation information. According to an embodiment of the present invention, in the theme zone providing system 100, whether the theme zone area is displayed on the route is set by the user. Also, when to provide an audio guidance point associated with the displayed theme zone area is set by the user.

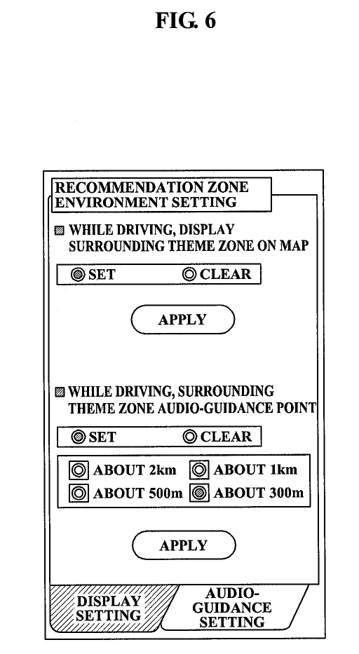

FIG. 6 is a diagram illustrating an example of a user interface screen setting an environment of a theme zone according to the present invention.

As illustrated in FIG. 6, a theme zone providing system 100 provides a user interface screen. A user may set or clear with respect to displaying of a theme zone area on a route via the user interface screen. When receiving whether to display the theme zone area on the route and receiving an ‘Apply’ click from the user, whether to display the theme zone area on the route is determined. As an example, when displaying of the theme zone area is set, the theme zone area is always displayed on the route. When displaying of the theme zone area is cleared, the theme zone area is not displayed on the route. However, although displaying of the theme zone area is not set, when retrieving the theme zone area, the theme zone area corresponding to a result of the retrieving may be always displayed on the route. Also, the theme zone providing system 100 provides the user interface screen. Distance information of an audio-guidance point associated with the theme zone may be set by the user via the user interface screen. Also, in the theme zone providing system 100, the distance information of the audio-guidance point may be set by the user to ‘about 2 km’, ‘about 1 km’, ‘about 500 m’, ‘about 300 m’, and the like.

Accordingly, the route guidance unit 105 of the theme zone providing system 100 may differently audio-guide according to information for each distance according to the distance information of the audio guidance point. In this instance, the information is associated with the theme zone on the driving route. As an example, the theme zone providing system 100 may provide an audio-guidance such as ‘There is a theme zone area about 2 km ahead’, ‘There is a theme zone area about 300 m ahead’, and the like.

According to another embodiment of the present invention, the theme zone providing system 100 displays a map associated with the driving route on the user interface screen. Also, the theme zone providing system 100 generates the navigation information to enable a theme zone representation icon to be located in a center of the theme zone area, when a position of the map is changed according to a vehicle's driving and the theme zone area is included in the map on the screen.

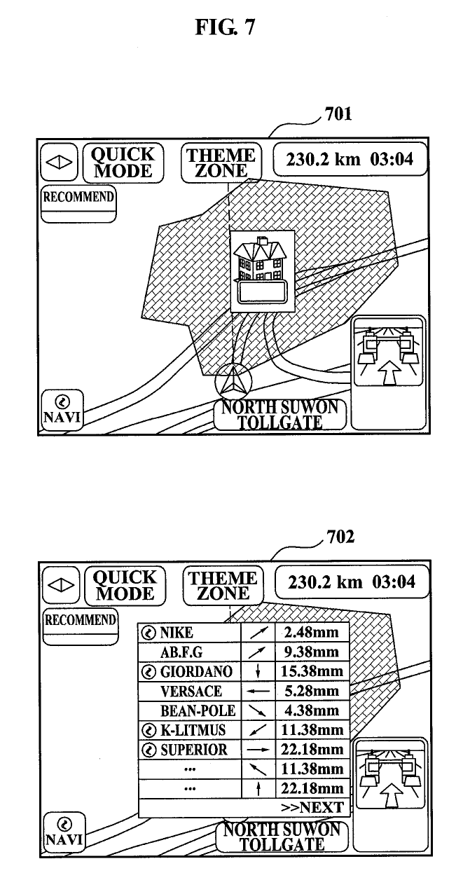

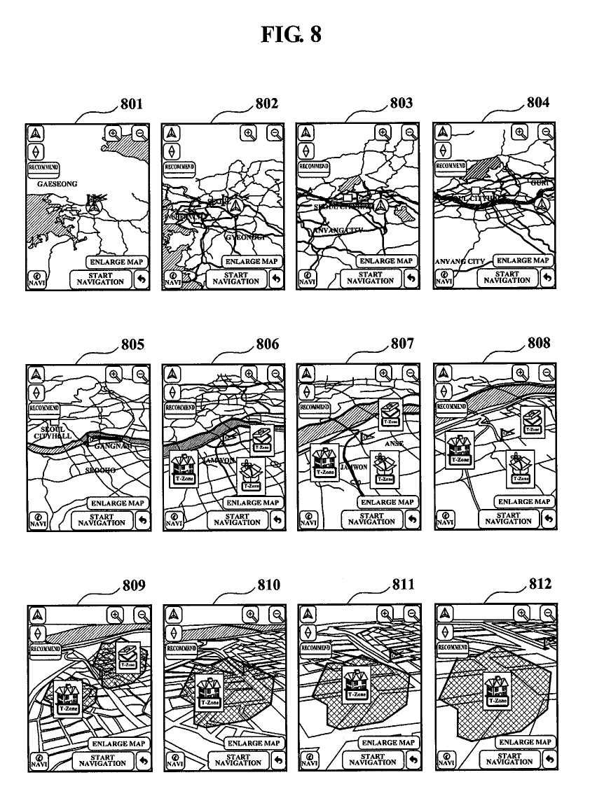

FIGS. 7 and 8 are diagrams illustrating examples of a user interface screen displaying a theme zone area on a route in a system for providing a theme zone in association with a route according to the present invention.

As illustrated in 701 of FIG. 7, a theme zone providing system 100 may locate a theme zone representation icon in a center of a theme zone area on a screen, when a position of the map is changed according to a vehicle's driving. As illustrated in 702 of FIG. 7, the theme zone providing system 100 may provide POI information included in the theme zone area as a list, when a user selects, i.e. clicks, the theme zone representation icon on the screen. The list includes detail information linked with each POI. When the user clicks each POI once again, the detail information linked with each POI may be displayed. Also, when the user selects the theme zone representation icon on the screen, each POI included in the theme zone area may be displayed in point form.

According to still another embodiment of the present invention, the theme zone providing system 100 may direct the route by 1) not displaying the theme zone area, 2) displaying the theme zone representation icon, or 3) displaying the theme zone representation icon and the theme zone area depending on a map level on the screen.

As illustrated in FIG. 8, the theme zone providing system 100 may differently display the theme zone area depending on the map level. 801, 802, 803, 804, and 805 of FIG. 8 illustrate examples where the theme zone area is not displayed on the screen. Only theme zone representation icon is displayed on the screen in 806, 807, 808, and 809 of FIG. 8. The theme zone representation icon and the theme zone area are displayed together on the screen in 810, 811, and 812 of FIG. 8.

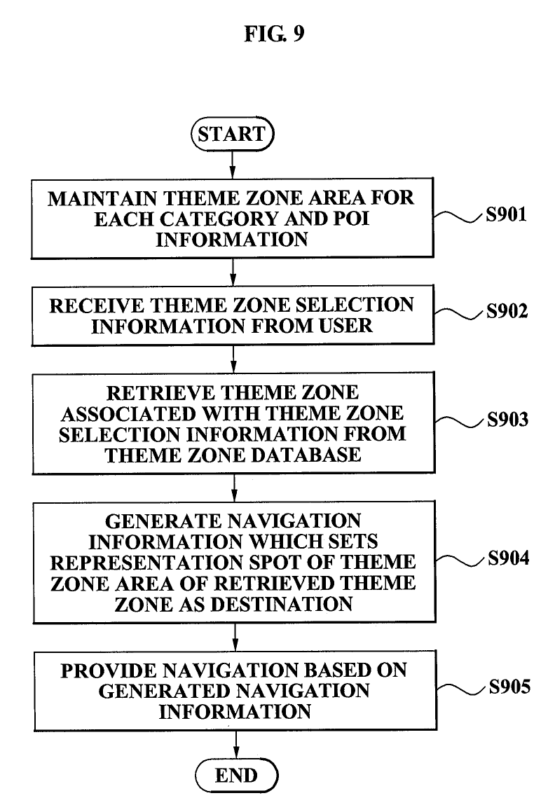

FIG. 9 is a flowchart illustrating a method of providing a theme zone in association with a route according to the still other embodiment of the present invention. As opposed to the embodiment described with reference to FIG. 2, in FIG. 9, a theme zone providing system 100 according to the still other embodiment of the present invention does not automatically provide a theme zone while driving, however, receives the theme zone from a user, and thereby may provide a route for the received theme zone.

In operation S901, the theme zone providing system 100 sets and stores a shop, which is located in a center of a coordinate of a theme zone area, as a representation spot in a theme zone database 101. To generate navigation information, coordinates of a point corresponding to a destination is generally required. Since the theme zone area is a two dimensional polygon area as opposed to a point, the center of the coordinate to generate the navigation information is required. Accordingly, the theme zone providing system 100 may set a center of a coordinate of the theme zone area as a point coordinate of the shop located in the center of the coordinate of the theme zone area and store the center of the coordinate of the theme zone area in the theme zone database 101.

In operation S902, the theme zone providing system 100 receives theme zone selection information from the user. The theme zone selection information may be information about a category, a district, a search radius of the theme zone, a keyword, and the like. The theme zone providing system 100 may receive the theme zone selection information from the user by providing a user interface screen illustrated in FIGS. 3, 4, and 5.

In operation S903, the theme zone providing system 100 retrieves a theme zone associated with the theme zone selection information from the theme zone database 101.

In operation S904, the theme zone providing system 100 generates the navigation information which sets the representation spot of the theme zone area of the retrieved theme zone as the destination.

In operation S905, the theme zone providing system 100 provides navigation based on the generated navigation information.

According to another embodiment of the present invention, the theme zone providing system 100 may be used in a web page, and previously maintain the theme zone database 101. Also, the theme zone providing system 100 may provide a theme zone list corresponding to theme zone selection information, inputted by the user, via a web browser or provide a route including the theme zone area.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

According to the present invention, a method and system for providing a theme zone in association with a route previously stores a theme zone area for each category, such as food, fashion, convenience, and the like, retrieves a theme zone associated with a driving route of a vehicle, includes a theme zone area of the retrieved theme zone in navigation information, directs a route, and thereby may enable a driver to easily recognize the theme zone.

Also, according to the present invention, a method and system for providing a theme zone in association with a route provides only a theme zone area included in a category on the route while driving when the category of the theme zone is previously set by a user, and thereby may provide different theme zones for each user.

Also, according to the present invention, a method and system for providing a theme zone in association with a route receives a district and a search radius of the theme zone from a user, retrieves and provides POI information associated with the received district and search radius.

Also, according to the present invention, a method and system for providing a theme zone in association with a route stores a recommendation theme zone list based on a theme zone use status of a user and provides the recommendation theme zone list when necessary.

1. A system for providing a theme zone in association with a route, the system comprising:
a theme zone database maintaining a theme zone area for each category in association with navigation information, and point of interest (POI) information included in the theme zone area;
a theme zone retrieval unit retrieving a theme zone associated with a driving route from the theme zone database by analyzing the driving route of a vehicle;
a navigation information generation unit generating the navigation information by including a theme zone area of the retrieved theme zone in the driving route; and
a route guidance unit directing a route based on the generated navigation information.

2. The system of claim 1, further comprising:
a user interface unit receiving a category of a theme zone from a user,
wherein the theme zone retrieval unit retrieves a theme zone included in the selected category in association with the driving route from the theme zone database, and the navigation information generation unit generates the navigation information by including a theme zone area of the theme zone included in the selected category in the driving route.

3. The system of claim 1, further comprising:
a user interface unit receiving a district and a search radius of the theme zone from a user,
wherein the theme zone retrieval unit retrieves POI information included in the district and the search radius of the theme zone from the theme zone database, and the route guidance unit provides the user with a theme zone list including the retrieved POI information.

4. The system of claim 1, wherein the theme zone database stores a recommendation theme zone list according to a theme zone use of a user, the theme zone retrieval unit receives a request for recommendation theme zone information from a user and retrieves the recommendation theme zone list from the theme zone database, and the route guidance unit provides the user with the retrieved recommendation theme zone list.

5. The system of claim 1, further comprising:
a user interface unit receiving distance information of an audio guidance point associated with the theme zone from a user,
wherein the route guidance unit differently audio-guides according to information for each distance according to the distance information of the audio guidance point, the information being associated with the theme zone on the driving route.

6. The system of claim 1, wherein the navigation information generation unit displays a map associated with the driving route on a screen, and generates the navigation information to enable a theme zone representation icon to be located in a center of the theme zone area, when a position of the map is changed according to a vehicle's driving and the theme zone area is included in the map on the screen.

7. The system of claim 1, wherein the route guidance unit directs the route by 1) not displaying the theme zone area, 2) displaying a theme zone representation icon, or 3) displaying the theme zone representation icon and the theme zone area depending on a map level on a screen.

8. A system for providing a theme zone in association with a route, the system comprising:
a theme zone database maintaining a theme zone area for each category in association with navigation information, and POI information included in the theme zone area;
a user interface unit receiving theme zone selection information from a user;
a theme zone retrieval unit retrieving a theme zone associated with the theme zone selection information from the theme zone database;
a navigation information generation unit generating the navigation information which sets a representation spot of a theme zone area of the retrieved theme zone as a destination; and
a route guidance unit providing navigation based on the generated navigation information.

9. The system of claim 8, wherein the theme zone database sets and stores a shop, which is located in a center of a coordinate of the theme zone area, as a representation spot, and the navigation information generation unit generates navigation information which sets a representation spot of the shop, which is located in the center of the coordinate of the theme zone area, as a destination.

10. A method of providing a theme zone in association with a route, the method comprising:
maintaining a theme zone area for each category in association with navigation information, and POI information included in the theme zone area in a theme zone database;
retrieving a theme zone associated with a driving route from the theme zone database by analyzing the driving route of a vehicle;
generating navigation information by including a theme zone area of the retrieved theme zone in the driving route; and
directing a route based on the generated navigation information.

11. The method of claim 10, further comprising:
receiving a category of a theme zone from a user,
wherein the retrieving comprises retrieving a theme zone included in the selected category in association with the driving route from the theme zone database, and the generating comprises generating navigation information by including a theme zone area of the theme zone included in the selected category in the driving route.

12. The method of claim 10, further comprising:
receiving a district and a search radius of the theme zone from a user,
wherein the retrieving comprises retrieving POI information included in the district and the search radius of the theme zone from the theme zone database, and the directing comprises providing the user with a theme zone list including the retrieved POI information.

13. The method of claim 10, further comprising:
receiving distance information of an audio guidance point associated with the theme zone from a user,
wherein the directing comprises information for differently audio-guiding for each distance according to the distance information of the audio guidance point, the information being associated with the theme zone on the driving route.

14. The method of claim 10, wherein the generating comprises displaying a map associated with the driving route on a screen, and generating navigation information to enable a theme zone representation icon to be located in a center of the theme zone area, when a position of the map is changed according to a vehicle's driving and the theme zone area is included in the map on the screen.

15. The method of claim 10, wherein the directing comprises directing the route by 1) not displaying the theme zone area, 2) displaying a theme zone representation icon, or 3) displaying the theme zone representation icon and the theme zone area depending on a map level on a screen.

16. A method of providing a theme zone in association with a route, the method comprising:
maintaining a theme zone area for each category in association with navigation information, and POI information included in the theme zone area;
receiving theme zone selection information from a user;
retrieving a theme zone associated with the theme zone selection information from the theme zone database;
generating the navigation information of a theme zone area of the retrieved theme zone; and
providing navigation based on the generated navigation information.

17. The method of claim 16, further comprising:
setting a shop, which is located in a center of a coordinate of the theme zone area, as a representation spot, and storing the shop in the theme zone database,
wherein the generating comprises generating navigation information which sets a representation spot of the shop, which is located in the center of the coordinate of the theme zone area, as a destination.

18. A computer-readable recording medium comprising computer instructions for:
maintaining a theme zone area for each category in association with navigation information, and POI information included in the theme zone area in a theme zone database;
retrieving a theme zone associated with a driving route from the theme zone database by analyzing the driving route of a vehicle;
generating navigation information by including a theme zone area of the retrieved theme zone in the driving route; and
directing a route based on the generated navigation information.
